(19) United States
(12) Patent Application Publication
(10) Pub. No.: US 2004/0114198 A1
(43) Pub. Date: Jun. 17, 2004

(54) Image processing system and method

(75) Inventors: Hyoung-Jo Jeon, Suwon city (KR); Jun-Bo Kim, Seoul city (KR); Hwa-Sub Shim, Suwon city (KR); Hyeong-Min Ahn, Seongnam city (KR); Min Hong, Seoul city (KR); Jae-Wan Kim, Namyangju city (KR); Ho-Seok Choi, Seoul city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/676,100

(22) Filed: Oct. 2, 2003

(30) Foreign Application Priority Data
Dec. 16, 2002 (KR) 2002-80340

(51) Int. Cl. H04N 1/04; H04N 1/46

(52) U.S. Cl. 358/474; 358/505

(57) ABSTRACT

An image processing system and an image processing method which correct a moiré in an image taken from a displayed image. An imaging taking apparatus takes an image of an image displayed by an image displaying apparatus and an optical characteristic changing apparatus is provided between the image taking apparatus and the image displaying apparatus. A lightpath of the displayed image is changed before the image of the displayed image is taken and an image processor receives a plurality of the taken images from the image taking apparatus and generates a processed image with a removed moiré by correcting or superposing the plurality of the images. Thus, a processed image, in which a moiré of the displayed image is removed, is promptly obtainable, and a quality of the taken image is increased. The image processing system and method are adaptable to various systems for inspection and/or measurement.

### CROSS-REFERENCE TO RELATED APPLICATIONS

This application claims the benefit of Korean Patent Application No. 2002-80340, filed Dec. 16, 2002, in the Korean Intellectual Property Office, the disclosure of which is incorporated herein by reference.

### BACKGROUND OF THE INVENTION

1. Field of the Invention

The present invention relates to an image processing system, and more particularly, to an image processing system and a method of image processing which removes a moiré existing in an image generated by photographing an image displayed in an image displaying apparatus, such as an LCD, with a camera.

2. Description of the Related Art

In a display apparatus, such as an LCD or a CRT, an object to inspect or measure, such as a soldered part or an electronic part, is displayed as an image according to a predetermined frequency. If the image displayed in the display apparatus is photographed by an image taking apparatus such as a CCD camera, a moiré, which does not exist in the original image, is presented in the photographed image due to a frequency difference between the displaying apparatus and the photographing apparatus. If the moiré in the photographed image of the object is not removed, accuracy and credibility for vision-based inspection or measurement are decreased.

Thus, before photographing an image displayed in the display apparatus, it is necessary to set up a state that the moiré is reduced. According to a conventional image processing system as shown in FIG. 4, by changing a resolution of an image displaying apparatus 300, by changing a filter/lens 200 mounted on an image taking apparatus 100 such as the CCD camera to change an optical characteristic, or by changing a size of an image, a processed image in which the moiré is reduced is generated in an image processor (not shown) provided in a main system 400. Also, the moiré may be reduced by making a manipulation such as defocusing by adjusting the image displaying apparatus 300 or the filter/lens 200.

However, excessive time is necessary to remove the moiré by using the above conventional methods, and repeating the same process whenever the image displaying apparatus is changed is annoying. In a case of defocusing or in a case of using a filter to remove the moiré, overall quality of the image is lowered. Thus, a problem occurs that clearness of the image is also decreased as the moiré is reduced. Further, even in a case that the moiré is set up as a most reduced state, if the resolution, a kind of the filter, the size of the image, or a focus state is optionally changed, the moiré may be generated again. Therefore, conditions where an acceptable processed image is obtainable from the image displaying apparatus are limited.

### SUMMARY OF THE INVENTION

Accordingly, it is an aspect of the present invention to provide an image processing system and a method of image processing which dynamically reduces a moiré by correcting and superposing images taken at various image taking positions using a lightpath changing apparatus.

Additional aspects and/or advantages of the invention will be set forth in part in the description which follows and, in part, will be obvious form the description, or may be learned by practice of the invention.

The foregoing and/or other aspects of the present invention are achieved by providing an image processing system comprising: an image displaying apparatus in which an image is displayed; an imaging taking apparatus to take the image displayed in the image displaying apparatus; an optical characteristic changing apparatus, provided between the image taking apparatus and the image displaying apparatus, and which changes optical characteristics of an image to be taken a lightpath changing apparatus which changes a light path of the displayed image to the image taking apparatus; and an image processor which receives a plurality of images having the changed lightpath from the image taking apparatus and generates a processed image with a moiré removed by correcting or superposing the plurality of the images.

In one aspect, the image processing system further comprises a position controller which controls the lightpath changing apparatus to change the lightpath of the image, wherein the image processor generates the processed image with the moiré removed by correcting or superposing the plurality of the images taken by the image taking apparatus through the lightpath changing apparatus along the lightpath changed by the position controller.

In another aspect, the position controller moves the image displaying apparatus to a plurality of predetermined positions and the image processor generates the processed image with the moiré removed by correcting or superposing a plurality of images taken by the image taking apparatus at the plurality of predetermined positions. Alternatively, the position controller moves the optical characteristic changing apparatus, the image taking apparatus and the light path changing apparatus to a plurality of positions and the image processor generates the processed image with the moiré removed by correcting or superimposing a plurality of images taken by the image taking apparatus at the plurality of predetermined positions.

The lightpath changing apparatus may operate in a manner of a galvanometer mirror or a prism.

In yet another aspect, the image processor generates a predetermined image processed with the moiré removed by correcting a shape or a brightness of the images.

The foregoing and/or other aspects of the present invention are also achieved by providing a method of processing an image in an image processing system having an image displaying apparatus to display an image of an object, an image taking apparatus to take an image of the displayed image; an optical characteristic changing apparatus provided between the image displaying apparatus and the image taking apparatus, and changing an optical characteristic of a taken image; and a lightpath changing apparatus changing a lightpath of the image displayed in the image displaying apparatus and transporting the image to the image taking apparatus, the method comprising: taking respective images from the image displaying apparatus at a plurality of respective image taking positions; correcting respective taken images; and generating a processed image in which a moiré is reduced by superposing corrected images on one another.

In one aspect of the method, the taking of the images comprises: moving to the respective image taking position by changing a lightpath of an image displayed in the image displaying apparatus with the lightpath changing apparatus; and taking the respective images from the image displaying apparatus at the respective image taking positions according to the changed lightpath.

In another aspect of the method, the moving to the respective image taking positions: moving the image displaying apparatus or the image taking apparatus to a predetermined position; and changing a lightpath of the image displayed in the image displaying apparatus by using the lightpath changing apparatus at the predetermined position.

In yet another aspect of the method, correcting the respective taken images comprises correcting a shape or a brightness of at least one of the respective images.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a block diagram illustrating an image processing system according to an embodiment of the present invention;

FIG. 2 is a block diagram illustrating movement of the image processing system according to the present invention;

FIG. 3 is a flow diagram illustrating an image processing process according to the present invention; and

FIG. 4 is a block diagram illustrating a conventional image processing system.

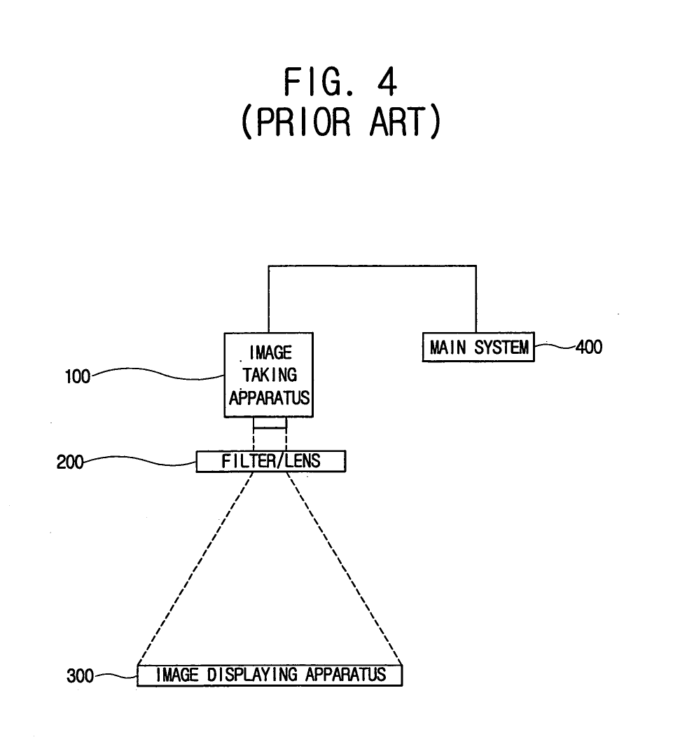

### DESCRIPTION OF THE PREFERRED EMBODIMENT

Reference will now be made in detail to the embodiments of the present invention, examples of which are illustrated in the accompanying drawings, wherein like reference numerals refer to like elements throughout.

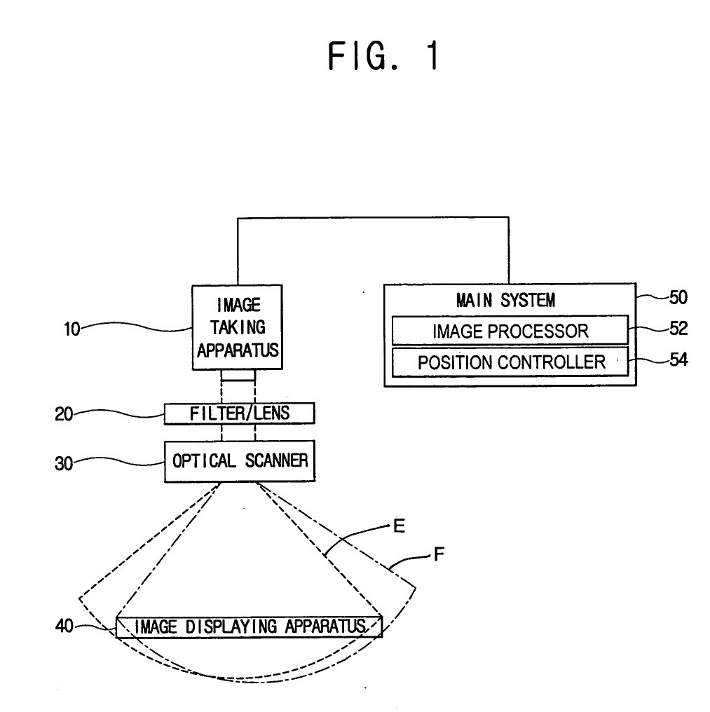

FIG. 1 is a block diagram illustrating an image processing system according to an embodiment of the present invention. As shown in FIG. 1, an imaging processing system comprises an image taking apparatus 10, such as for example, a CCD camera which photographs a displayed image; an image displaying apparatus 40, such as for example, an LCD, which displays an object to inspect or measure as an image; a filter/lens 20, provided between the image taking apparatus 10 and the image displaying apparatus 40, which changes optical characteristics of an image to be taken; an optical scanner 30 which varies a lightpath of the image displayed in the image displaying apparatus 40 and provides the image to the image taking apparatus 10; and a main system 50 which generates a processed image without a moiré by using a plurality of images provided from the image taking apparatus 10.

The main system 50 comprises an image processor 52 which generates the processed image with the moiré removed by correcting or superposing the plurality of the images; a position controller 54 which controls changes of the lightpath of the image provided to the optical scanner 30. Also, the position controller 54 moves the image displaying apparatus 40, the image taking apparatus 10, the filter/lens 20, and the optical scanner 30 to a predetermined position and allows the image displayed in the image displaying apparatus 40 to be photographed at the moved position.

The filter/lens 20 changes optical characteristics of the image provided from the image displaying apparatus 40, allowing the image to be defocused or a size of the image to be adjusted by using various specifications of the filters or lenses thereof.

The optical scanner 30 changes the lightpath of the image provided from the image displaying apparatus 40 by using a mirror apparatus (not shown) provided in the optical scanner 30. The change of the lightpath is implemented in a manner of a prism or a galvanometer mirror using a galvanometer as an actuator to control movement of the mirror apparatus. Alternatively, the optical scanner 30 may be configured in such a manner that the optical scanner 30 is moved according to a control signal of the position controller 54 by a separate driving part (not shown) to allow the lightpath to be changed.

The position controller 54 provides a control signal to change the lightpath to the optical scanner 30 and thus enables a plurality of images varied according to different lightpaths to be provided to the image taking apparatus 10. The change of the lightpath may be configured in such a manner that the plurality of the images may be taken by being processed at a high speed according to a predetermined setup value.] The optical scanner 30 may be disposed between the image displaying apparatus 40 and the filter/lens 20 or between the filter/lens 20 and the image taking apparatus 10.

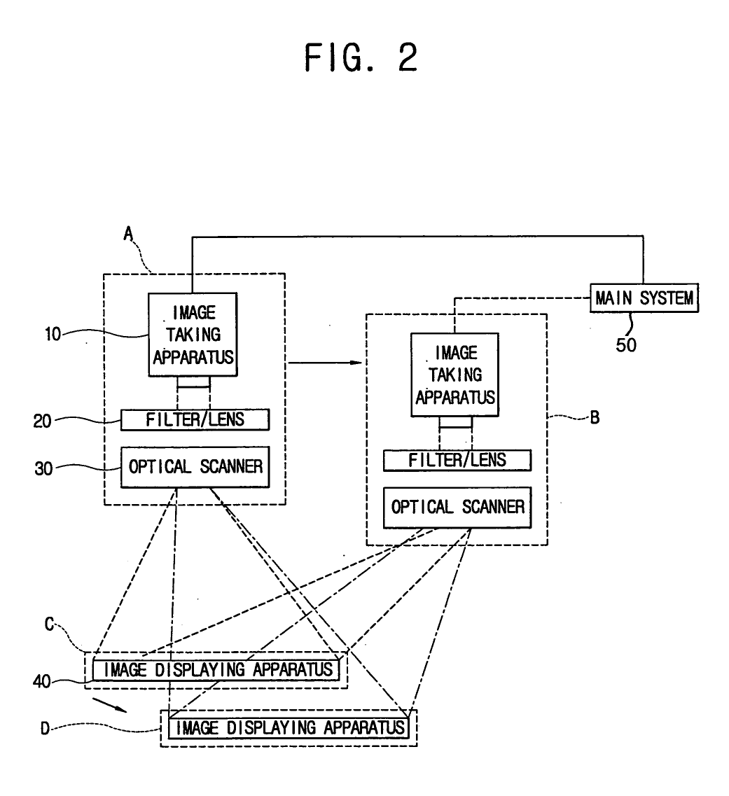

FIG. 2 is a block diagram illustrating movement within the image processing system according to the present invention. As shown in FIG. 2, the position controller 54 (FIG. 1) of the main system 50 controls the image displaying apparatus 40 by using a separate driving apparatus (not shown) so that the image displaying apparatus 40 is moveable to an intended position (such as for example, movement from a position C to a position D as shown in FIG. 2). The image taking apparatus 10, the filter/lens 20, and the optical scanner 30 may be controlled by a separate driving apparatus so that the image taking apparatus 10, the filter/lens 20 and the optical scanner are moveable to predetermined positions (such as for example, movement from a position A to a position B as shown in FIG. 2). Accordingly, the image taking apparatus 10 photographs an image displayed in the image displaying apparatus 40 at different positions and provides an obtained image to the image processor 52. An image whose lightpath is changed may also be taken at a predetermined position for taking the image.

The image processor 52 receives the plurality of the images according to changed lightpaths, or a plurality of images photographed by the movement to the predetermined positions and removes the moiré. Paths E and F of FIG. 1 represent different lightpaths. Respective images whose lightpaths are different from one another have a difference in size or brightness. That is, images are taken by the image taking apparatus 10 at a state that an aspect ratio of the displayed image varies according to a reflection angle of the mirror apparatus provided in the optical scanner 30 relative to a surface of the image displaying apparatus 40, and the taken images having the varying aspect ratio are provided to the image processor 52. Also, the brightness of the taken images may be varied according to a reflection distance between mirror planes provided in the image displaying apparatus 40 and the optical scanner 30. In a case that the image displaying apparatus 40, or the image taking apparatus 10 is moved as shown in FIG. 2, the size and the brightness of the taken image is variable according to a distance between the image displaying apparatus 40 and the image taking apparatus 10.

Thus, in order to generate an image processed with the moiré removed, the size of each taken image is adjusted to be equal to the size of the processed image. In adjusting the size of a respective image, it may also be necessary to adjust the aspect ratio of each taken image to be equal to the vertical vs. horizontal ratio of the processed image. The brightness of each image is adjusted to be equal to a predetermined reference brightness. The image processor 52 superposes respective images, whose size and brightness are adjusted after being provided from the image taking apparatus 10, on one another and generates a new superposed image. If the adjusted images are superposed, a shape of an object actually displayed in the image displaying apparatus 40 is enforced and a moiré which would have existed in the individual images is reduced, to thereby prevent quality deterioration of the generated image. The inspection and the measurement are performed by using the superposed processed image.

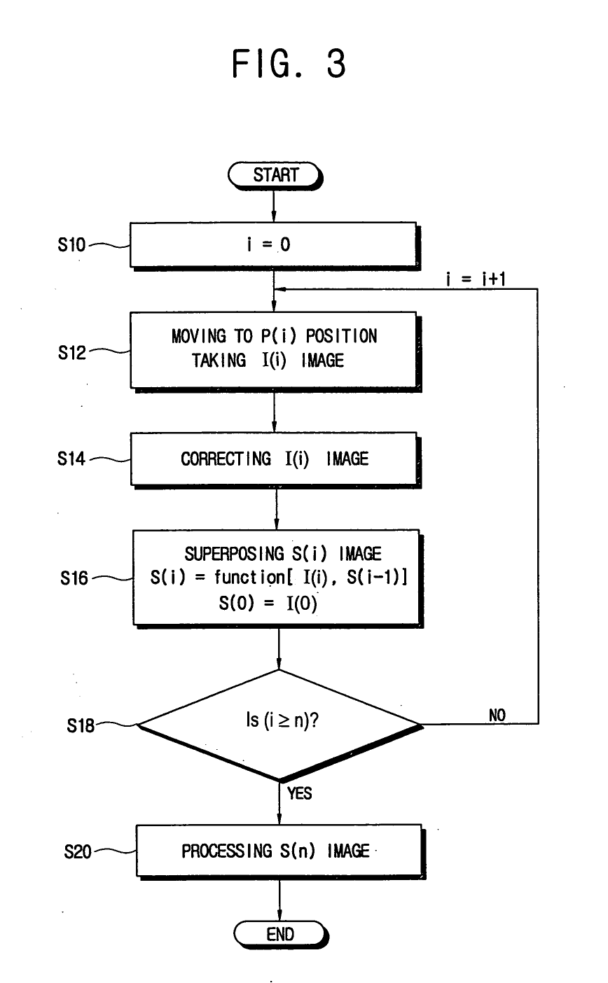

Referring now to FIG. 3, a method of processing an image using the image processing system according to the present invention is illustrated. The image taking apparatus 10 and the optical scanner 30 are moved to an image taking position so as to take an image displayed in the image displaying apparatus 40 at operation S10. In the foregoing explanation, a position at which an image is taken is denoted as P(i), where i ranges from 0, which represents an initial position to n, which represents a number of times an image is to be taken. In a case that the optical scanner 30 and the image taking apparatus 10 are moved from an initial image taking position P(0) to a next image taking position P(i), the optical scanner 30 and the image taking apparatus 10 may be moved to a predetermined image taking position by changing the lightpath of the optical scanner 30 (refer to FIG. 1), or by moving the image displaying apparatus 40 and the image taking apparatus 10 to a relative position (refer to FIG. 2).

An initial value of i is set to be 0 at operation S10. At an intended position P(i), an image I(i) is taken from the image displaying apparatus 40 by the image taking apparatus 10 at operation S12. The image taken by the image taking apparatus 10 is provided to the image processor 52 and at operation S14, the image processor 52 corrects the image for at least one of aspect ratio, size and brightness as described above. If i=0, the corrected image is provided to the processor 52 as an initial image. If i>0, the corrected image is superposed on the initial image by the image processor 52, so that a superposed image S(i) is generated at operation S16. After the superposed image is generated, operations S12 through S16 are repeated until a predetermined number n of image taking times is determined to have been reached at operation S18 (S18). Images are taken as many as an intended number of times at each movement position and superposed. Thus, a superposed image S(n) is subsequently generated, to thereby obtain an image with the moiré removed at operation S20. The superposed image S(i) becomes a function of the image I(i) and the superposed image S(i-1). A process of the image processor 52 may be set up so that the correcting of the image which is performed at operation S14 is performed after superposing the image at operation 16.

As the number of image superposing times is increased, the moiré reduction effect is increased. Thus, the larger the number of the image taking times, the more preferable the generated image. However, if a certain limit is reached due to a quantization error of an image induced by a difference between a processed image signal and an original image signal, the moiré reduction effect is not further increased in the superposed image and the image quality maintains a constant level. Thus, the number of the image taking times should be set up to be repeated in an appropriate level, allowing for the reduction effect of the moiré.

Also, in a case that the number of the image taking times is set up as small in order to minimize the repeating of operations S12 through S16 to provide high speed image processing, a separate moiré processor may be provided in the image processor 52 to remove the moiré.

In summary, according to the present invention, in order to remove a moiré from the image taken from the image displaying apparatus, the plurality of the images taken by changing the lightpath or by changing the image taking position are corrected and superposed. Thus, it is not necessary to find a setup state that the moiré is relatively small as in the conventional apparatus, and the quality of the image is improved according to the present invention by correcting and superposing the images. Also, even though a model of the image displaying apparatus is changed, independent of a setup state of an object whose image is to be taken, a processed image with the moiré dynamically removed is promptly provided, to thereby enable efficiency of a vision-based inspection or measurement to be increased.

As described above, according to the present invention, a processed image in which a moiré of an image taken through an image taking apparatus from an image displaying apparatus is removed is promptly obtainable, and a quality of a taken image is increased. The invention may be suitably adapted to various kinds of inspection or measurement which display an image of a part to be inspected or measured.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An image processing system comprising:
an image displaying apparatus which displays an image;
an imaging taking apparatus to take the image displayed in the image displaying apparatus;
an optical characteristic changing apparatus, provided between the image taking apparatus and the image displaying apparatus, which changes optical characteristics of the displayed image;
a lightpath changing apparatus which changes a lightpath of the displayed image; and
an image processor which receives a plurality of images having respective changed lightpaths from the image taking apparatus and generates a processed image with a moiréremoved by correcting or superposing the plurality of the images.

2. The image processing system according to claim 1, further comprising:
a position controller which controls the lightpath changing apparatus to change the lightpaths of the respective images.

3. The image processing system according to claim 2, wherein:
the position controller moves the image displaying apparatus to a plurality of predetermined positions,
the image taking apparatus takes an image of the displayed image at each of the plurality of the predetermined positions, and
the image processor generates the processed image with the moiré removed by correcting or superposing the plurality of the images taken by the image taking apparatus at the plurality of predetermined positions.

4. The image processing system according to claim 2, wherein:
the position controller moves the optical characteristic changing apparatus, the image taking apparatus and the lightpath changing apparatus to a plurality of predetermined positions,
the image taking apparatus takes an image at each of the plurality of the predetermined positions, and
the image processor generates the processed image with the moiré removed by correcting or superposing the plurality of the images taken by the image taking apparatus at the plurality of predetermined positions.

5. The image processing system according to claim 1, wherein the lightpath changing apparatus operates in a manner of one of galvanometer mirror and a prism.

6. The image processing system according to claim 2, wherein the lightpath changing apparatus operates in a manner of one of a galvanometer mirror and a prism.

7. The image processing system according to claim 1, wherein the image processor generates an image processed with the moiré removed by correcting a shape or a brightness of each image.

8. The image processing system according to claim 2, wherein the image processor generates an image processed, with the moiré removed by correcting a shape or a brightness of each image.

9. The image processing system according to claim 3, wherein the image processor generates an image processed with the moiré removed by correcting a shape or a brightness of each image.

10. The image processing system according to claim 4, wherein the image processor generates an image processed with the moiré removed by correcting a shape or a brightness of each image.

11. A method of processing an image in an image processing system having an image displaying apparatus to display an image of an object, an image taking apparatus to take the image from the image displaying apparatus, an optical characteristic changing apparatus provided between the image displaying apparatus and the image taking apparatus which changes an optical characteristic of a taken image, and a lightpath changing apparatus which changes a lightpath of the image displayed in the image displaying apparatus and transports the image to the image taking apparatus, the method comprising:
taking respective images from the image displaying apparatus at a plurality of respective image taking positions;
correcting the respective taken images; and
generating a processed image in which a moiré is reduced by superposing the corrected images on one another.

12. The method according to claim 11, wherein the taking of the images comprises:
moving to the respective image taking position by changing a lightpath of the displayed image; and
taking the respective images from the image displaying apparatus at the respective image taking positions according to the changed lightpath.

13. The method according to claim 11, wherein the moving to the respective image taking positions comprises:
moving the image displaying apparatus or the image taking apparatus to a predetermined position; and
changing the lightpath of the image displayed in the image displaying apparatus at the predetermined position.

14. The method according to claim 11, wherein the correcting of the respective taken images comprises:
correcting a shape or a brightness of the respective images.

15. The method according to claim 12, wherein the correcting of the respective taken images comprises correcting a shape or a brightness of the respective images.

16. The method according to claim 13, wherein the correcting of the respective taken images comprises:
correcting a shape or a brightness of the respective images.

17. A method of reducing a moiré in an image taken of an image displayed on a display apparatus, the method comprising;
taking a first image of the displayed image from a first position;
taking a second image of the displayed image from a second position; and
superposing the first and second images to generate a processed image.

18. The method of claim 17, further comprising:
adjusting an aspect ratio of one of the first and second images prior to superposing the first and second images.

19. The method of claim 17, further comprising:
adjusting a brightness of one of the first and second images prior to superposing the first and second images.

20. The method of claim 17, further comprising:
taking an additional image from an additional position and superposing the additional image with the first and second images to generated the processed image.

21. The method of claim 20, further comprising:
repeating the taking and the superposing of the images for a predetermined number of times.

22. The method of claim 17, further comprising:
taking a plurality of additional images from a respective plurality of different positions and sequentially superposing each additional image on a processed image comprising previously superposed images.

23. A method of reducing a moiré in an image taken of an image displayed on a display apparatus, the method comprising;
taking a plurality of images of the displayed image from a respective plurality of different positions;
adjusting at least one of a size and a brightness of at least one of the plurality of images; and
superposing at least two of the images to generate a processed image having a minimized moiré.

24. An apparatus for producing an image of an image displayed on an image displaying device at a predetermined frequency, the apparatus comprising:
a camera which takes a plurality images of the displayed image,
a motion control system which:
controls a relative position of the camera with respect to the image displaying apparatus, and
sequentially adjusts the relative position so that each of the plurality of images is taken at a different position; and
an image processor which:
adjusts each of the taken images to a predetermined size and brightness, and
superposes the adjusted images to generate a resultant image having a minimum moiré.

25. The apparatus of claim 24, further comprising:
an optical scanner which transfers the displayed image to the camera.
